(19) United States
(12) Patent Application Publication
(10) Pub. No.: US 2026/0056400 A1
(43) Pub. Date: Feb. 26, 2026

(54) WAVELENGTH CONVERSION DEVICE, PROJECTION DEVICE AND METHOD FOR MANUFACTURING COUNTERWEIGHT

(71) Applicant: Coretronic Corporation, Hsin-Chu (TW)

(72) Inventor: I-Hua Chen, Hsin-Chu (TW)

(73) Assignee: Coretronic Corporation, Hsin-Chu (TW)

(21) Appl. No.: 19/296,960

(22) Filed: Aug. 12, 2025

(30) Foreign Application Priority Data
Aug. 23, 2024 (CN) 202411164775.2

(51) Int. Cl. G02B 26/00; G03B 21/20

(52) U.S. Cl. CPC G02B 26/008; G03B 21/204

(57) ABSTRACT

A wavelength conversion device including a wavelength conversion module and a driving assembly is provided. The driving assembly is suitable for driving the wavelength conversion module to rotate while taking a central axis as a rotating axis. The wavelength conversion module includes a disc, a wavelength conversion layer and a counterweight. The wavelength conversion layer is disposed on a bearing surface of the disc. The counterweight is disposed on the disc. The counterweight is closer to the central axis relative to the wavelength conversion layer. The counterweight includes a first counterweight element. A plurality of particles of the first counterweight element are evenly distributed in a first photo-curable material of the first counterweight element to form the first counterweight element. In a direction parallel to the central axis, a plurality of particle orthogonal projections of the plurality of particles on the bearing surface at least partially overlap.

### CROSS-REFERENCE TO RELATED APPLICATION

This application claims the priority benefit of China application serial no. 202411164775.2 filed on Aug. 23, 2024. The entirety of the above-mentioned patent application is hereby incorporated by reference herein and made a part of this specification.

### BACKGROUND

### Technical Field

The invention relates to an optical device, a projection device and a method for manufacturing a counterweight, and particularly relates to a wavelength conversion device, a projection device having the wavelength conversion device and a method for manufacturing a counterweight adapted to the wavelength conversion device.

### Description of Related Art

A phosphor wheel structure in a projection device (such as a projector) is driven by a driving assembly (such as a motor) to rotate. In order to reduce a centrifugal force caused by an uneven mass distribution of the phosphor wheel structure relative to an axis of the driving assembly, dynamic balancing is performed during a manufacturing process of the phosphor wheel structure so that the phosphor wheel structure may operate smoothly. Generally, there are two dynamic balance correction methods, which are respectively a correction method of increasing mass and a correction method of reducing mass, where the correction method of increasing mass is to correct the phenomenon of uneven mass distribution of the phosphor wheel structure by adding a balancing material to the phosphor wheel structure.

For example, the correction method of increasing mass may be to fix a metal sheet on a surface of the phosphor wheel structure through adhesive. However, when the metal sheet is heavy or rotated at a high speed, the metal sheet is easier to fall off, causing the phosphor wheel structure to produce greater vibration and noise when rotating, and leading to damage of the motor.

Furthermore, if the above method is used, it may not be conducive to fine adjustment of weight. Because fine adjustment of weight requires the use of tiny metal sheets, but it is not easy to operate by using the tiny metal sheets to adjust weight. In addition, metal sheets of different sizes require different amounts of adhesive to adhere to the surface of the phosphor wheel structure, but different amounts of adhesive will also affect a total weight. Therefore, even if a total amount of counterweight required is known, it is difficult to calculate the weight of the metal sheet and the amount of adhesive to be used, and it is difficult to make fine adjustment.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a wavelength conversion device, which has better structural reliability and is adapted to adjust a phenomenon of uneven mass distribution of a wavelength conversion module.

The invention is directed to a projection device, which includes the above-mentioned wavelength conversion device and have higher reliability and longer service life.

The invention is directed to a method for manufacturing a counterweight, which is adapted to the above-mentioned wavelength conversion device.

Additional aspects and advantages of the present invention will be set forth in the description of the techniques disclosed in the present invention.

In order to achieve the above object, the invention provides a wavelength conversion device including a wavelength conversion module and a driving assembly. The driving assembly is suitable for driving the wavelength conversion module to rotate while taking a central axis as a rotating axis. The wavelength conversion module includes a disc, a wavelength conversion layer and a counterweight. The disc has a center located on the central axis and has a bearing surface perpendicular to the central axis. The wavelength conversion layer is disposed on the bearing surface of the disc. The counterweight is disposed on the disc, and in a radial direction perpendicular to the central axis, the counterweight is closer to the central axis relative to the wavelength conversion layer. The counterweight includes a first counterweight element, and the first counterweight element includes a first photo-curable material and a plurality of particles. The plurality of particles are evenly distributed in the first photo-curable material to form the first counterweight element. In a direction parallel to the central axis, a plurality of particle orthogonal projections of the plurality of particles on the bearing surface at least partially overlap.

In order to achieve the above object, the invention provides a projection device including an illumination module, a light valve and a projection lens. The illumination module is configured to provide an illumination beam, and the illumination module includes a light source device and a wavelength conversion device. The light source device is configured to provide an excited beam. The wavelength conversion device is disposed on a transmission path of the excited beam, and the wavelength conversion device includes a wavelength conversion module and a driving assembly. The driving assembly is suitable for driving the wavelength conversion module to rotate while taking a central axis as a rotating axis. The wavelength conversion module includes a disc, a wavelength conversion layer and a counterweight. The disc has a center located on the central axis and has a bearing surface perpendicular to the central axis. The wavelength conversion layer is disposed on the bearing surface of the disc. The counterweight is disposed on the disc, and in a radial direction perpendicular to the central axis, the counterweight is closer to the central axis relative to the wavelength conversion layer. The counterweight includes a first counterweight element, and the first counterweight element includes a first photo-curable material and a plurality of particles. The plurality of particles are evenly distributed in the first photo-curable material to form the first counterweight element. In a direction parallel to the central axis, a plurality of particle orthogonal projections of the plurality of particles on the bearing surface at least partially overlap. The light valve is disposed on a transmission path of the illumination beam to convert the illumination beam into an image beam. The projection lens is disposed on a transmission path of the image beam to project the image beam out of the projection device.

In order to achieve the above object, the invention provides a method for manufacturing a counterweight, which is adapted to the above-mentioned wavelength conversion device. The method for manufacturing the counterweight includes: providing an uncured first photo-curable material, adding a plurality of particles to the uncured first photo-curable material and mixing evenly; filling the uncured first photo-curable material mixed with the plurality of particles into a syringe and performing defoaming, disposing the uncured first photo-curable material mixed with the plurality of particles on a disc; and curing to form the counterweight.

Based on the above description, embodiments of the invention have at least one of the following advantages or effects. In the wavelength conversion device of the invention, the counterweight includes a first counterweight element. The first counterweight element is formed by evenly distributing a plurality of particles in the first photo-curable material, which may increase adhesion between the first counterweight element and the disc, and it is easy to use coating to control a position of the counterweight, so as to achieve finer adjustments.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2A is a schematic three-dimensional view of a wavelength conversion device of FIG. 1.

FIG. 2B is a schematic cross-sectional view of the wavelength conversion device of FIG. 2A.

FIG. 2C is a partially enlarged schematic diagram of the wavelength conversion device of FIG. 2B.

FIG. 2D is a schematic side view of the wavelength conversion device of FIG. 2C.

FIG. 3 is a schematic partial side view of a wavelength conversion device according to an embodiment of the invention.

FIG. 4A is a schematic three-dimensional diagram of a wavelength conversion device according to an embodiment of the invention.

FIG. 4B is a schematic cross-sectional view of the wavelength conversion device of FIG. 4A.

FIG. 4C is a partially enlarged schematic diagram of the wavelength conversion device of FIG. 4B.

FIG. 5A is a schematic front view of a wavelength conversion device according to an embodiment of the invention.

FIG. 5B is a schematic cross-sectional view of the wavelength conversion device of FIG. 5A.

FIG. 6A is a flowchart of a method for manufacturing a counterweight according to an embodiment of the invention.

FIG. 6B is another flowchart of a method for manufacturing a counterweight according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “left,” “right,” “front,” “back,” etc., is used with reference to the orientation of the Figure(s) being described and are not intended to be limiting of the invention.

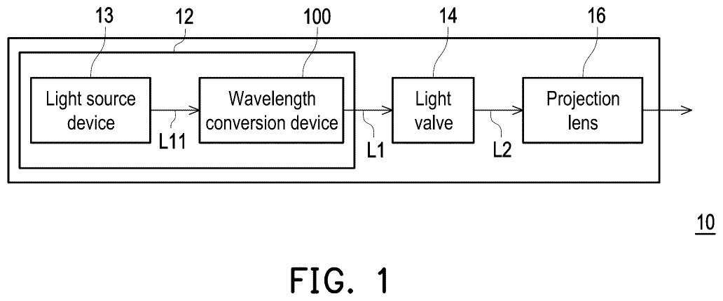

FIG. 1 is a schematic diagram of a projection device according to an embodiment of the invention. Referring to FIG. 1, in the embodiment, the projection device 10 includes an illumination module 12, a light valve 14 and a projection lens 16. The illumination module 12 is configured to provide an illumination beam L1. The illumination module 12 includes a light source device 13 and a wavelength conversion device 100. The light source device 13 is configured to provide a laser beam L11. The wavelength conversion device 100 is disposed on a transmission path of the laser beam L11 to generate the illumination beam L1. The light valve 14 is disposed on a transmission path of the illumination beam L1 to convert the illumination beam L1 into an image beam L2. The projection lens 16 is disposed on a transmission path of the image beam L2 to project the image beam L2 out of the projection device 10.

In detail, the light source device 13 used in the embodiment is, for example, a laser diode (LD), and is, for example, one laser diode or a laser diode bank, where when the light source device 13 includes a plurality of laser diodes, some of laser beams emitted by the diodes may not be incident to the wavelength conversion device 100, or all of the laser beams emitted by the laser diodes may be incident to the wavelength conversion device 100. In other embodiments, the light source device 13 is, for example, a combination of a light-emitting diode (LED) and a laser diode, where a light beam generated by the LED may not be incident to the wavelength conversion device 100. Specifically, any light source device that meets a volume requirement in actual design may be implemented, which is not limited by the invention. The light valve 14 is, for example, a reflective light modulator such as a liquid crystal on silicon panel (LCoS panel) or a digital micro-mirror device (DMD). In an embodiment, the light valve 14 is, for example, a transparent liquid crystal panel, an electro-optical modulator, a magneto-optic modulator, or an acousto-optic modulator (AOM), or other transmissive optical modulators, but the embodiment does not limit the form and type of the light valve 14. Regarding detailed steps and implementation of the method for the light valve 14 to convert the illumination beam L1 from the illumination module 12 into the image beam L2, sufficient teachings, suggestions and implementation instructions may be obtained from common knowledge in the technical field, and details thereof are not repeated. In addition, the projection lens 16 includes, for example, a combination of one or a plurality of optical lenses with refractive power, such as various combinations of non-planar lenses including biconcave lenses, biconvex lenses, concavo-convex lenses, convexo-concave lenses, plano-convex lenses, plano-concave lenses, etc. In an embodiment, the projection lens 16 may also include a planar optical lens to project the image beam L2 from the light valve 14 out of the projection device 10 in a reflective or transmissive manner to form a projection image. Here, the embodiment does not limit the form and type of the projection lens 16.

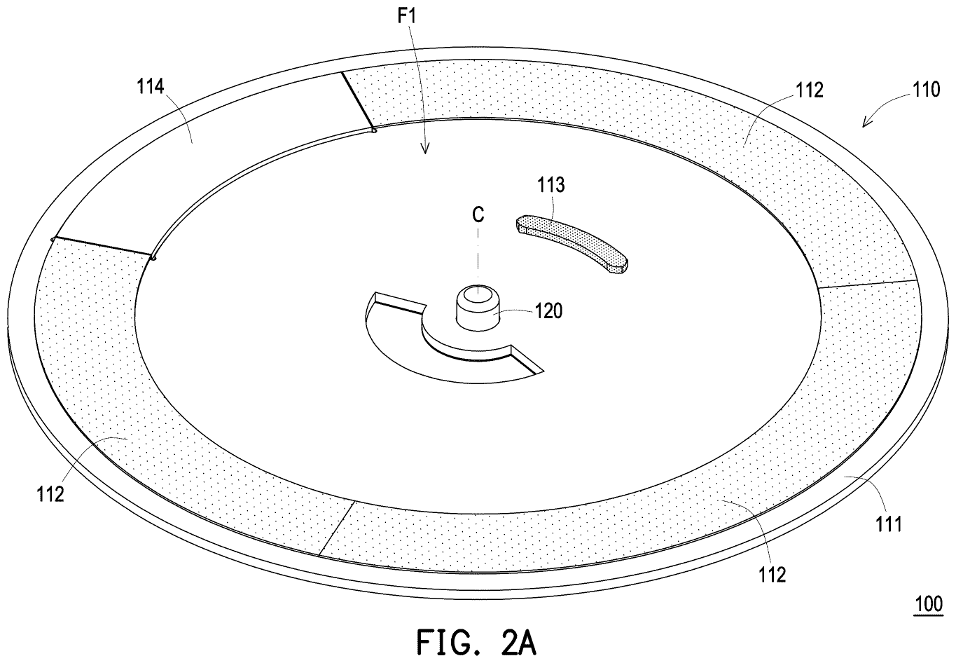

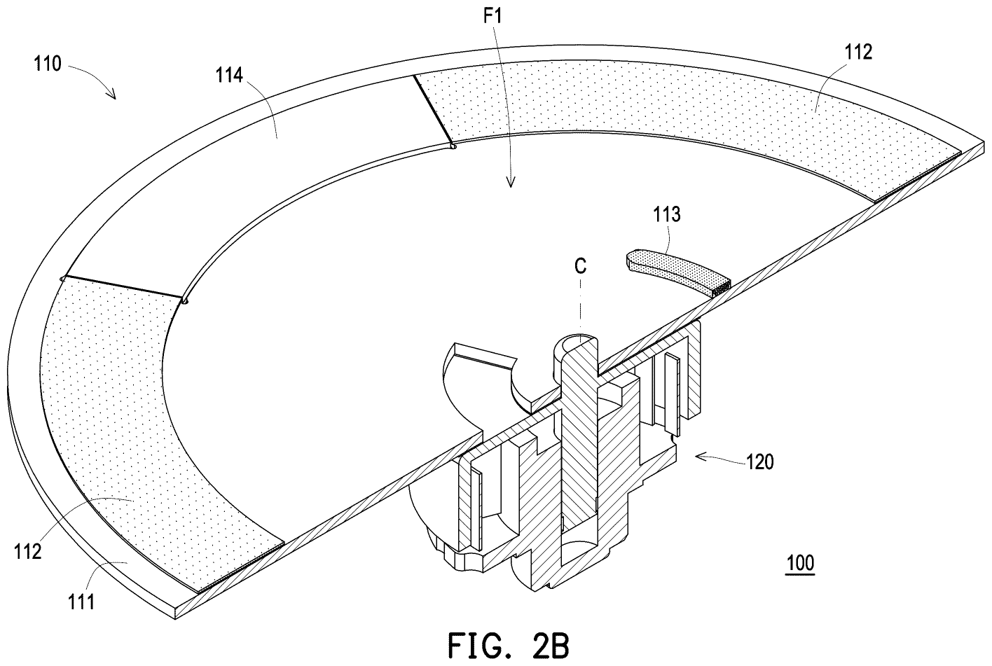

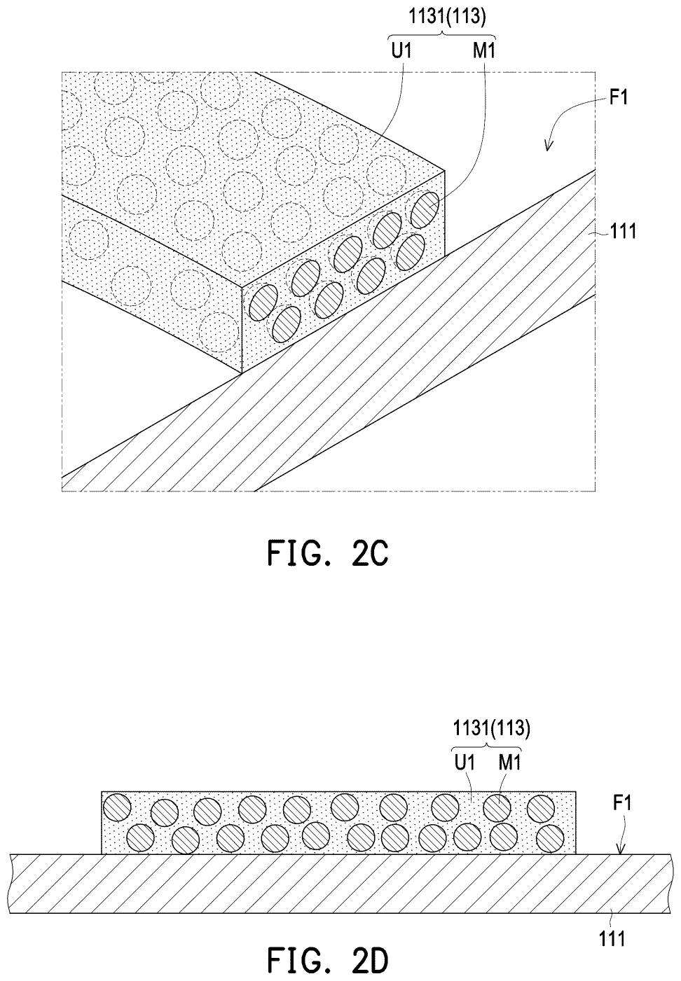

FIG. 2A is a three-dimensional schematic view of the wavelength conversion device of FIG. 1. FIG. 2B is a schematic cross-sectional view of the wavelength conversion device of FIG. 2A. FIG. 2C is a partially enlarged schematic diagram of the wavelength conversion device of FIG. 2B. FIG. 2D is a schematic side view of the wavelength conversion device of FIG. 2C. Referring to FIG. 2A, FIG. 2B, FIG. 2C and FIG. 2D, in the embodiment, the wavelength conversion device 100 includes a wavelength conversion module 110 and a driving assembly 120. The driving assembly 120 is adapted to drive the wavelength conversion module 110 to rotate while taking a central axis C as a rotation axis. Specifically, the wavelength conversion module 110 includes a disc 111, a wavelength conversion layer 112 and a counterweight 113.

In the embodiment, a center of the disc 111 is located on the central axis C and has a bearing surface F1 perpendicular to the central axis C. The wavelength conversion layer 112 is disposed on the bearing surface F1 of the disc 111, and the wavelength conversion layer 112 may, for example, be in a complete ring shape or a partial ring shape around the central axis C. The wavelength conversion layer 112 is disposed on a transmission path of the laser beam L11. Here, the driving assembly 120 is, for example, a motor. A material of the disc 111 is metal, such as aluminum, aluminum alloy, copper or stainless steel, etc., and the wavelength conversion layer 112 is, for example, a phosphor layer. The wavelength conversion layer 112, for example, includes a plurality of different phosphor layers for respectively converting the laser beam into light beams of different wavelengths. As shown in FIG. 2A, the wavelength conversion layer 112 includes three phosphor layers, for example, phosphor layers that may convert the laser beam into red light, green light, and yellow light. By using the driving assembly 120 to drive the wavelength conversion module 110 to rotate while taking the central axis C as a rotating axis, the three phosphor layers sequentially enter the transmission path of the laser beam, thereby sequentially converting the laser beam into red light, green light, and yellow light, and the red light, the green light, and the yellow light are sequentially transmitted to the light valve as illumination beams, but the invention is not limited thereto.

In another embodiment, the wavelength conversion device 100 further includes a transparent plate 114, the disc 111 includes, for example, an opening (not numbered), and a shape of the transparent plate 114, for example, matches a shape of the opening for being disposed in the opening of the disc 111. The transparent plate 114 and the wavelength conversion layer 112 may be arranged in a complete ring pattern. A material of the transparent plate 114 is, for example, glass or plastic to allow the laser beam to pass through. The driving assembly 120 drives the wavelength conversion module 110 to rotate while taking the central axis C as the rotating axis, and the three phosphor layers and the transparent plate 114 sequentially enter the transmission path of the laser beam, so that the red light, the green light, the yellow light and the blue light are sequentially transmitted to the light valve as illumination beams. In other embodiments, the disc 111 may not be provided with an opening, and the disc 111 may have a blue light reflection region (not shown). The blue light reflection region may be arranged with the wavelength conversion layer 112 to form a complete ring shape pattern, and the wavelength conversion module is driven by the driving assembly 120 to rotate while taking the central axis C as the rotating axis, and the three phosphor layers and the blue light reflection region sequentially enter the transmission path of the laser beam, so that the red light, the green light, the yellow light and the blue light are sequentially transmitted to the light valve as illumination beams.

In the embodiment, the counterweight 113 is disposed on the disc 111, and in a radial direction perpendicular to the central axis C, the counterweight 113 is closer to the central axis C relative to the wavelength conversion layer 112. To be specific, the counterweight 113 includes a first counterweight element 1131. The first counterweight element 1131 includes a first photo-curable material U1 and a plurality of particles M1. The plurality of particles M1 are evenly distributed in the first photo-curable material U1 to form the first counterweight element 1131. In a direction parallel to the central axis C, a plurality of particle orthogonal projections of the plurality of particles M1 on the bearing surface F1 at least partially overlap.

Under the above configuration, the plurality of particles M1 are mixed with the uncured first photo-curable material U1, and after curing, the first weight element 1131 is formed. In this way, the first photo-curable material U1 that is mixed with the plurality of particles M1 and has not yet been cured is directly coated on the bearing surface F1 of the disc 111 and cured, and the first counterweight element 1131 formed after curing may correct imbalance. The coating method makes it easy to control a position of the counterweight, allowing for finer adjustments and facilitating automated operations.

Other embodiments are provided below as illustrations. It should be noticed that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

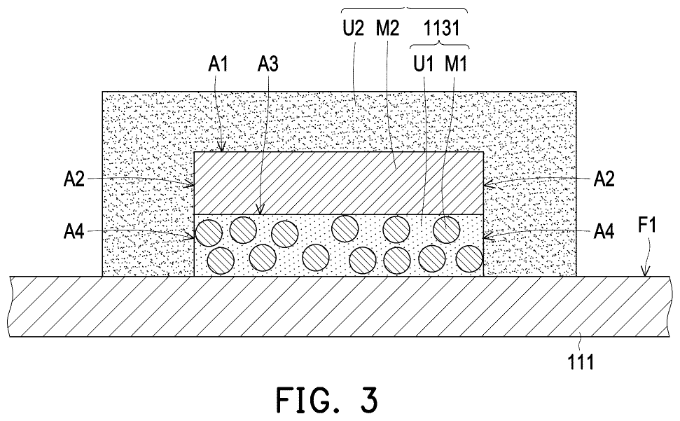

FIG. 3 is a schematic partial side view of a wavelength conversion device according to an embodiment of the invention. Referring to FIG. 3, a counterweight 113B is slightly different from the counterweight 113 of FIG. 2D, and a main difference there between is that the counterweight 113B further includes a second photo-curable material U2 and a second counterweight element M2. The first counterweight element 1131 is disposed between the second counterweight element M2 and the disc 111, and the second photo-curable material U2 covers the second counterweight element M2 and the first counterweight element 1131 and is fixed on the disc 111. Here, the second photo-curable material U2 is an ultraviolet curable resin (UV glue) without being mixed with particles, i.e., pure UV glue, but the invention is not limited thereto.

Further, in the embodiment, the second counterweight element M2 has a first surface A1 and a second surface A2. The first surface A1 is not parallel to the second surface A2, and the first surface A1 and the second surface A2 are covered by the second photo-curable material U2. Here, the first surface A1 refers to an upper surface of the second counterweight element M2 away from the disc 111, the second surface A2 refers to an entire side surface of the second counterweight element M2, and the second surface A2 (the side surface) surrounds and is connected to the entire periphery of the first surface A1.

In the embodiment, the first counterweight element 1131 has a third surface A3 in contact with the second counterweight element M2, and the first counterweight element 1131 has a fourth surface A4 that is not parallel to the third surface A3, and, the fourth surface A4 is covered with the second photo-curable material U2. Here, the fourth surface A4 refers to an entire side surface of the first counterweight element 1131, and the fourth surface A4 (the side surface) surrounds and is connected to the entire periphery of the third surface A3.

In an embodiment, the second counterweight element M2 may be in a sheet form, but the invention is not limited thereto. In an embodiment, a material of the second counterweight element M2 is copper, steel, tin or nickel, but the invention is not limited thereto.

In an embodiment, the first photo-curable material U1 may be the same ultraviolet curable resin (UV glue) as the second photo-curable material U2, but the invention is not limited thereto. Before photo curing, a viscosity of the uncured first photo-curable material U1 mixed with the plurality of particles M1 is greater than a viscosity of the uncured second photo-curable material U2. For example, before photo curing, the viscosity of the uncured first photo-curable material U1 mixed with the plurality of particles M1 is greater than 60000 cps, but the invention is not limited thereto.

In an embodiment, the plurality of particles M1 need to be small enough to be evenly dispersed in the first photo-curable material U1. For example, a particle diameter of each particle M1 is less than or equal to 100 μm, but the invention is not limited thereto. In an embodiment, the particle diameter of each particle M1 is greater than or equal to 10 μm and less than or equal to 100 μm, which may improve a bonding strength, but the invention is not limited thereto. In an embodiment, a density of the particles M1 is greater than 2.5 grams/cubic centimeter (g/cm³), but the invention is not limited thereto.

In an embodiment, the plurality of particles M1 are copper particles, steel particles, tin particles, nickel particles, alumina particles, zirconium oxide particles, aluminum nitride particles, titanium carbide particles, titanium nitride particles, phosphor particles or combinations thereof, but the invention is not limited thereto. In an embodiment, the plurality of particles M1 are metal particles or ceramic particles, but the invention is not limited thereto.

In an embodiment, a volume percentage of the plurality of particles M1 in the entire first counterweight element 1131 is, for example, 10 vol % to 50 vol %, so as to effectively affect the overall viscosity of the first counterweight element 1131, but the invention is not limited thereto.

In this way, the uncured first photo-curable material U1 mixed with the plurality of particles M1 may be disposed on the bearing surface F1 of the disc 111 first, and then the second counterweight element M2 is disposed on the uncured first photo-curable material U1 mixed with the plurality of particles M1, and then the uncured second photo-curable material U2 is applied to cover the second counterweight element M2 and the uncured first photo-curable material U1 mixed with the plurality of particles M1, and then curing is performed to form the counterweight 113B.

Generally, as a conventional method involves direct contact between the metal sheet and the disc, or even if there is adhesive between the metal sheet and the disc, but an amount of infiltration is minimal, so that a bonding force between the metal sheet and the disc is not firm. If the UV glue is first applied to coat on the disc, then the metal sheet is placed on the UV glue, and then covered with more UV glue, since the UV glue has not enough viscosity, the UV glue may spread to the surroundings during the initial coating, and finally there is still only a thin UV glue layer at a position where the metal sheet is placed, which also cannot effectively provide the bonding strength between the metal sheet and the disc. Moreover, since a thickness of the UV glue between the metal sheet and the bearing surface of the disc is very thin, a gap between the metal sheet and the disc that may allow ultraviolet light to enter is very small, so that it is difficult for the ultraviolet light to reach the UV glue under the metal sheet, making it difficult for the UV glue to cure. Therefore, the wavelength conversion device of the invention may mitigate the above problem.

In the embodiment, the viscosity of the uncured first photo-curable material U1 mixed with the plurality of particles M1 is much higher than that of UV glue without mixed particles. Therefore, before configuring the second counterweight element M2 (for example, a metal sheet), the uncured first photo-curable material U1 mixed with the plurality of particles M1 is first disposed on the disc 111, and the uncured first photo-curable material U1 mixed with the plurality of particles M1 is not easy to flow around. In this way, there is sufficient amount of adhesion or sufficient thickness of adhesion between the second counterweight element M2 and the bearing surface F1 of the disc 111. Therefore, the gap between the second counterweight element M2 and the disc 111 that allows ultraviolet light to irradiate is relatively large, so that the ultraviolet light may easily irradiate the uncured first photo-curable material U1 mixed with the plurality of particles M1 between the second counterweight element M2 and the disc 111, and the uncured first photo-curable material U1 mixed with the plurality of particles M1 is completely cured to form the first counterweight element 1131, thereby effectively improving the bonding strength between the second counterweight element M2 and the disc 111.

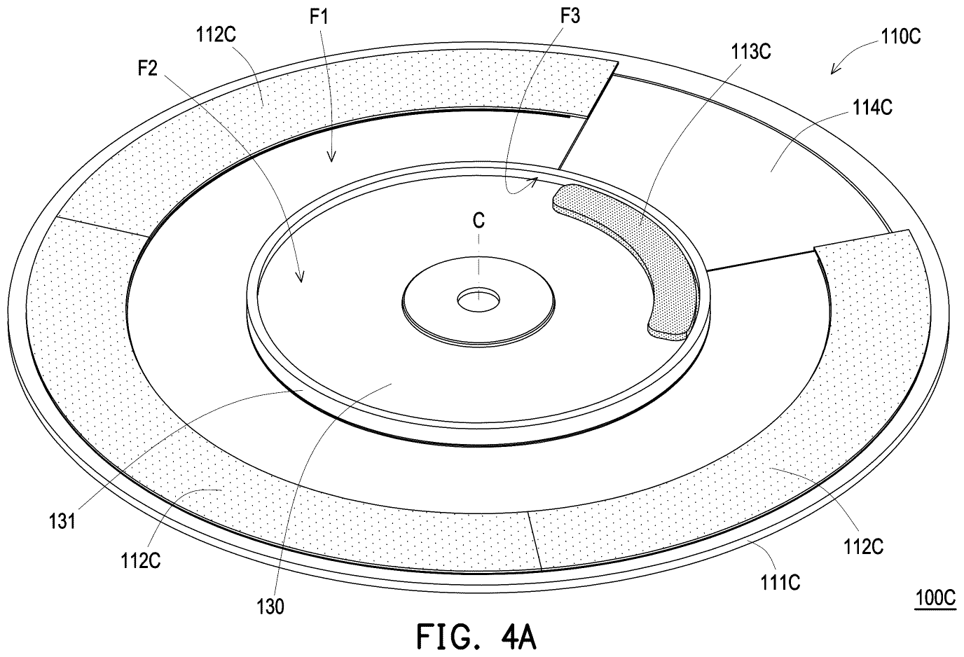

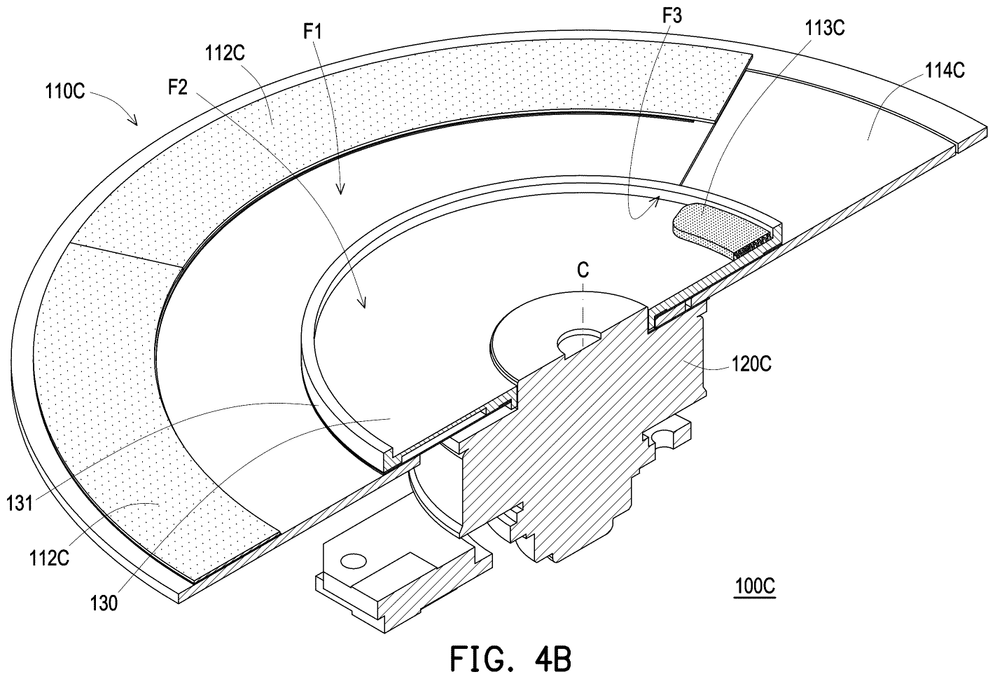

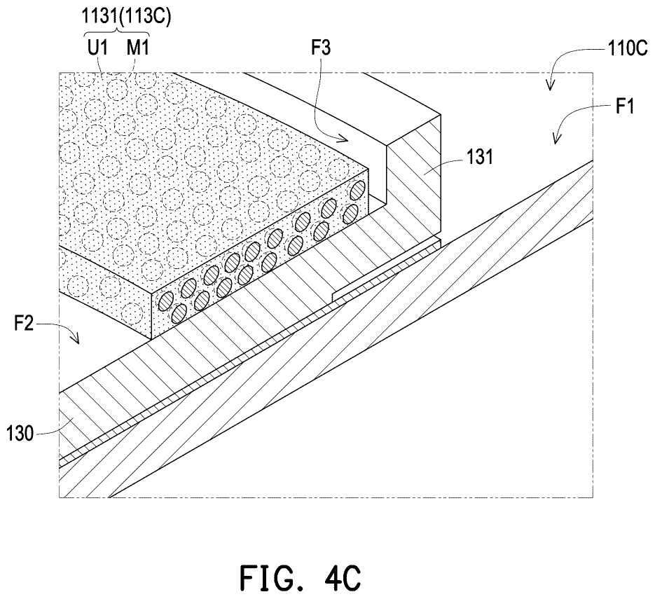

FIG. 4A is a three-dimensional schematic diagram of a wavelength conversion device according to an embodiment of the invention. FIG. 4B is a schematic cross-sectional view of the wavelength conversion device of FIG. 4A. FIG. 4C is a partially enlarged schematic diagram of the wavelength conversion device of FIG. 4B. Referring to FIG. 4A to FIG. 4C, a wavelength conversion device 100C is slightly different from the wavelength conversion device 100 of FIG. 2A, and the main differences are: the wavelength conversion device 100C further includes a plate body 130, where the plate body 130 is disposed on the bearing surface F1 of a disc 111C, a center of the plate body 130 is located on the central axis C, and in the direction parallel to the central axis C, an orthogonal projection of the plate body 130 on the bearing surface F1 does not overlap an orthogonal projection of a wavelength conversion layer 112C on the bearing surface F1. In addition, the wavelength conversion layer 112C and a transparent plate 114C are arranged in a ring shape, where the orthogonal projection of the plate body 130 on the bearing surface F1 partially overlaps an orthogonal projection of the transparent plate 114C on the bearing surface F1.

In another embodiment, the orthogonal projection of the plate body 130 on the bearing surface F1 may not overlap the orthogonal projection of the transparent plate 114C on the bearing surface F1 at all.

Further, in the embodiment, the plate body 130 further includes an annular convex wall 131 surrounding the central axis C. The annular convex wall 131 protrudes from a surface F2 of the plate body 130 along a direction parallel to the central axis C and in a direction away from the bearing surface F1. A counterweight 113C is disposed on the surface F2 of the plate body 130 and is partially fixed to an inner surface F3 of the annular convex wall 131. The inner surface F3 refers to an annular surface of the annular convex wall 131 facing the central axis C, but the invention is not limited thereto.

An effect of the above design is to enhance a fixing effect of the counterweight 113C, so that when the counterweight 113C is heavy or the wavelength conversion module 110C is rotated at a high speed, the counterweight 113C is prevented from falling off.

It should be noted that the counterweight 113C here includes the first counterweight element 1131, but in other embodiments, the counterweight 113C may also have a structure as shown in FIG. 3. Namely, the counterweight 113C may include the first counterweight element 1131, the second photo-curable material U2, and the second counterweight element M2, which is not limited by the invention.

As shown in FIG. 4A, in the embodiment, there is a gap between the plate body 130 and the wavelength conversion layer 112C in a direction perpendicular to the central axis C, but the invention is not limited thereto. An effect of such design is that since the laser beam needs to be incident to the wavelength conversion layer 112C through a lens element (not shown), the lens element is usually provided in front of the wavelength conversion layer 112C. Therefore, the above design of the gap may prevent the lens element from colliding with the annular convex wall 131 during rotation.

In the embodiment, the plate body 130 and the disc 111C are two-piece components. However, in other embodiments, the plate body 130 and the disc 111C may also be integrally formed, which is not limited by the invention.

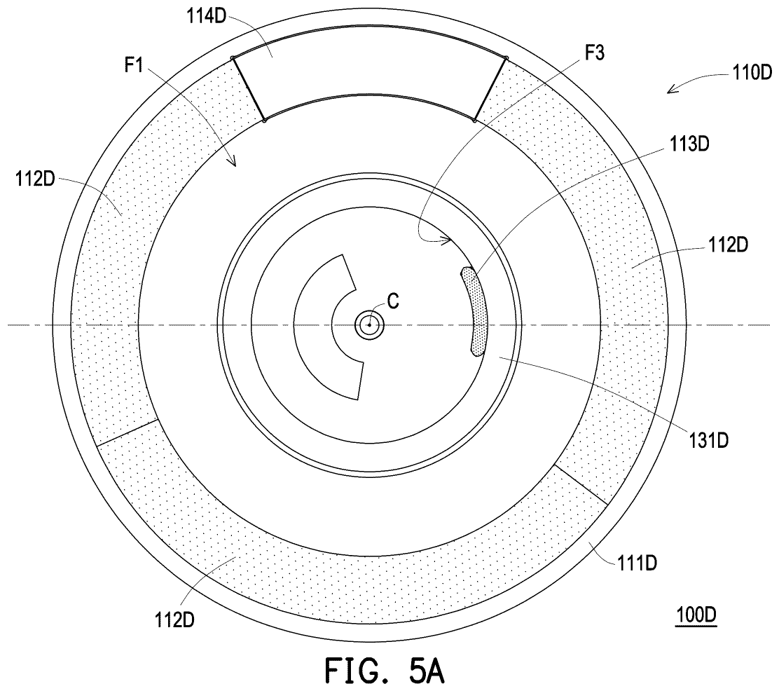

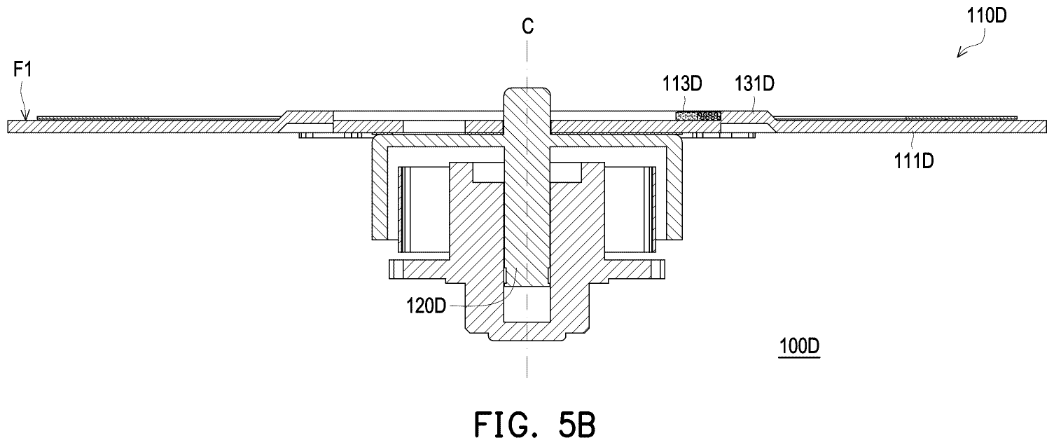

FIG. 5A is a schematic front view of a wavelength conversion device according to an embodiment of the invention. FIG. 5B is a schematic cross-sectional view of the wavelength conversion device of FIG. 5A. Referring to FIG. 5A and FIG. 5B, in the embodiment, a disc 111D of a wavelength conversion device 100D includes an annular convex wall 131D surrounding the central axis C, the annular convex wall 131D protrudes from the bearing surface F1 in a direction parallel to the central axis C, and in the direction parallel to the central axis C, an orthogonal projection of the annular convex wall 131D on the bearing surface F1 does not overlap an orthogonal projection of the wavelength conversion layer 112D on the bearing surface F1, and a counterweight 113D is disposed on the inner surface F3 of the annular convex wall 131D. Namely, the disc 111D and the annular convex wall 131D are integrally formed, but the invention is not limited thereto.

In the embodiment, the wavelength conversion layer 112D and a transparent plate 114D are arranged in a complete ring pattern. Therefore, in the direction parallel to the central axis C, the orthogonal projection of the annular convex wall 131D on the bearing surface F1 does not overlap an orthogonal projection of the transparent plate 114D on the bearing surface F1.

In the embodiment, the inner surface F3 refers to an annular surface of the annular convex wall 131D facing the central axis C, but the invention is not limited thereto. An effect of such design is that when the counterweight 113D is heavier or the wavelength conversion module 110D rotates at a high speed, the counterweight 113D may be prevented from falling off, so as to enhance a fixing effect of the counterweight 113D.

The following is a description of a method for manufacturing a counterweight.

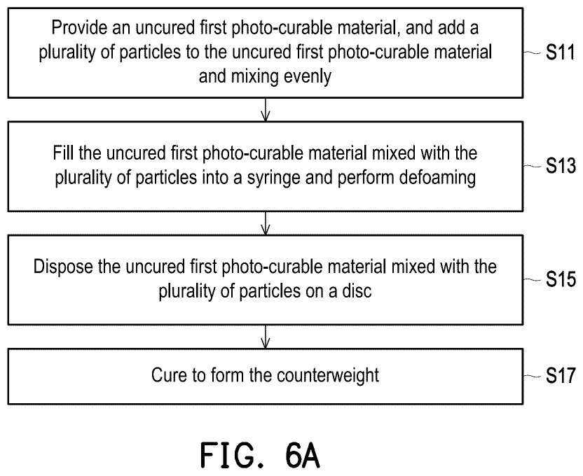

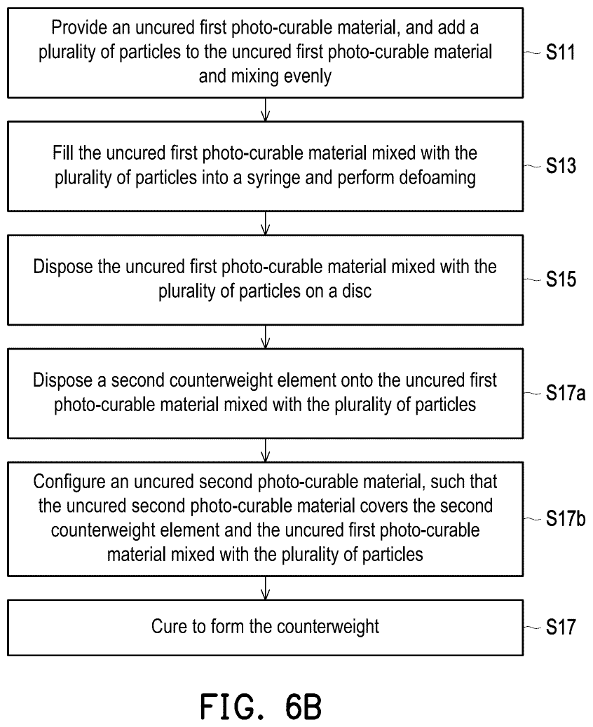

FIG. 6A is a flowchart of a method for manufacturing a counterweight according to an embodiment of the invention. Referring to FIG. 6A, in the embodiment, the method for manufacturing a counterweight is applicable to the aforementioned wavelength conversion device and projection device.

Taking the first counterweight element 1131 of FIG. 2D as an example, the method for manufacturing the first counterweight component 1131 includes, for example, step S11 shown in FIG. 6A, first, an uncured first photo-curable material is provided, and a plurality of particles M1 are added to the uncured first photo-curable material and mixed evenly. Then, in step S13, the uncured first photo-curable material mixed with the plurality of particles is filled into a syringe to perform defoaming. Then, in step S15, the uncured first photo-curable material mixed with the plurality of particles M1 is disposed on the bearing surface of the disc 111. In step S17, ultraviolet light is used to irradiate the uncured first photo-curable material mixed with the plurality of particles M1 for curing, so as to form the counterweight (i.e., the first counterweight element 1131).

FIG. 6B is another flowchart of a method for manufacturing a counterweight according to an embodiment of the invention. The method for manufacturing a counterweight of the embodiment is similar to that of FIG. 6A, and a difference there between is that after step S15, step S17a is executed in the embodiment to dispose the second counterweight element M2 onto the uncured first photo-cured material mixed with the plurality of particles M1. Then, step S17b is performed to configure the second photo-curable material so that the second photo-curable material covers the second counterweight element M2 and the uncured first photo-curable material mixed with the plurality of particles M1, and then step S17 is executed, where curing is performed by ultraviolet light irradiation to form the counterweight 113B, where the ultraviolet light may cure the uncured first photo-curable material mixed with the plurality of particles M1 to form the first counterweight element. The manufacturing method of the embodiment may take the counterweight 113B in FIG. 3 as an example.

In an embodiment, particles of different densities may be mixed with a photo-curable material to obtain the first weight element 1131 of a specific weight through proportional blending, for example, 1 g/mm³, 5 g/mm³, or 10 g/mm³, and if a significant balance adjustment is required, 10 g/mm³ may be used. If a relatively small balance adjustment is required, 1 g/mm³ and 5 g/mm³ may be used, but the invention is not limited thereto. In this way, the first counterweight elements 1131 with different weights may be mixed and matched for use.

Furthermore, metal particles with a density greater than 2.5 g/cm³, such as copper, steel, tin, and nickel may be adopted, but the invention is not limited thereto. Ceramic particles with a density greater than 2.5 g/cm³, such as aluminum oxide, zirconium oxide, aluminum nitride, titanium carbide, titanium nitride may be adopted, but the invention is not limited thereto.

In an embodiment, aluminum oxide and titanium oxide may be used as diffuse reflection particles of a diffuse reflection layer of the wavelength conversion device. The diffuse reflection layer is, for example, a layer with a scattering function provided on the disc 111 and located between the wavelength conversion layer 112 and the disc 111. Therefore, the first counterweight element 1131 of the invention may use the same material as the diffuse reflection layer, but the invention is not limited thereto. In an embodiment, the plurality of particles M1 may also be a particulate wavelength conversion material, such as phosphor powder. Therefore, the counterweight of the invention may use the same material as that of the wavelength conversion layer 112, but the invention is not limited thereto.

The defoaming mentioned in step S13 refers to elimination of bubbles. Specifically, for example, the uncured first photo-curable material mixed with the plurality of particles M1 is filled into a syringe, and the syringe is placed in a centrifugal defoamer to perform defoaming

In an embodiment, a test method for confirming whether the plurality of particles M1 and the uncured first photo-curable material are mixed evenly is, for example, to dispense the uncured first photo-curable material mixed with the plurality of particles M1, so as to test whether a density value thereof is within the preset range, and if the density value is within a preset range, it means that the plurality of particles M1 are evenly distributed in the first photo-curable material.

In addition, in step S15, a method of placing the uncured first photo-curable material mixed with the plurality of particles M1 on the disc 111 is, for example, to dispense the same on the disc 111 with a syringe.

In summary, in the projection device of the invention, the plurality of particles and the first photo-curable material are evenly mixed, the uncured first photo-curable material mixed with the plurality of particles may be coated on the bearing surface of the disc, and after curing, a counterweight is formed to correct the imbalance. According to such method, it is easier to control a position of the counterweight through coating, which allows to perform finer adjustments. In an embodiment, the counterweight further includes a second photo-curable material and a second counterweight element. A viscosity of the uncured first photo-curable material mixed with the plurality of particles is much higher than that of pure UV glue. In this way, even if the uncured first photo-curable material mixed with the plurality of particles is disposed on the disc first before the second counterweight element is disposed, the uncured first photo-curable material mixed with the plurality of particles is not likely to flow around. This ensures sufficient adhesion, or sufficient thickness of adhesion, between the second counterweight element and the bearing surface of the disc. Therefore, the gap between the second counterweight element and the disc that allows ultraviolet light to irradiate is relatively large, making it easy for ultraviolet light to irradiate the uncured first photo-curable material mixed with the plurality of particles, thereby effectively improving the bonding strength.

It will be apparent to those skilled in the art that various modifications and variations can be made to the disclosed embodiments without departing from the scope or spirit of the invention. In view of the foregoing, it is intended that the invention cover s modifications and variations provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion device, comprising a wavelength conversion module and a driving assembly, the driving assembly being suitable for driving the wavelength conversion module to rotate while taking a central axis as a rotating axis, the wavelength conversion module comprising a disc, a wavelength conversion layer and a counterweight, wherein:
the disc has a center located on the central axis and has a bearing surface perpendicular to the central axis;
the wavelength conversion layer is disposed on the bearing surface of the disc; and
the counterweight is disposed on the disc, and in a radial direction perpendicular to the central axis, the counterweight is closer to the central axis relative to the wavelength conversion layer, the counterweight comprises a first counterweight element, and the first counterweight element comprises a first photo-curable material and a plurality of particles, the plurality of particles are evenly distributed in the first photo-curable material to form the first counterweight element, and in a direction parallel to the central axis, a plurality of particle orthogonal projections of the plurality of particles on the bearing surface at least partially overlap.

2. The wavelength conversion device as claimed in claim 1, wherein the counterweight further comprises a second photo-curable material and a second counterweight element, the first counterweight element is arranged between the second counterweight element and the disc, and the second photo-curable material covers the second counterweight element and the first counterweight element and is fixed to the disc.

3. The wavelength conversion device as claimed in claim 2, wherein the second counterweight element has a first surface and a second surface, the first surface is not parallel to the second surface, and the first surface and the second surface are covered by the second photo-curable material.

4. The wavelength conversion device as claimed in claim 3, wherein the first counterweight element has a third surface in contact with the second counterweight element, the first counterweight element has a fourth surface that is not parallel to the third surface, and the fourth surface is covered by the second photo-curable material.

5. The wavelength conversion device as claimed in claim 2, wherein the second counterweight element is in a sheet form.

6. The wavelength conversion device as claimed in claim 2, wherein the second counterweight element is made of copper, steel, tin or nickel.

7. The wavelength conversion device as claimed in claim 1, further comprising a plate body disposed on the bearing surface of the disc, wherein a center of the plate body is located on the central axis, and in the direction parallel to the central axis, an orthogonal projection of the plate body on the bearing surface does not overlap an orthogonal projection of the wavelength conversion layer on the bearing surface.

8. The wavelength conversion device as claimed in claim 7, wherein the plate body further comprises an annular convex wall surrounding the central axis, the annular convex wall protrudes from a surface of the plate body along the direction parallel to the central axis and in a direction away from the bearing surface, and the counterweight is disposed on an inner surface of the annular convex wall.

9. The wavelength conversion device as claimed in claim 1, wherein the disc comprises an annular convex wall surrounding the central axis, the annular convex wall protrudes from the bearing surface along the direction parallel to the central axis, wherein in the direction parallel to the central axis, an orthogonal projection of the annular convex wall on the bearing surface does not overlap an orthogonal projection of the wavelength conversion layer on the bearing surface, and the counterweight is disposed on an inner surface of the annular convex wall.

10. The wavelength conversion device as claimed in claim 1, wherein a particle diameter of each of the plurality of particles is less than or equal to 100 μm.

11. The wavelength conversion device as claimed in claim 1, wherein a particle diameter of each of the plurality of particles is greater than or equal to 10 μm and less than or equal to 100 μm.

12. The wavelength conversion device as claimed in claim 1, wherein a density of the plurality of particles is greater than 2.5 grams/cubic centimeter (g/cm³).

13. The wavelength conversion device as claimed in claim 1, wherein the plurality of particles are copper particles, steel particles, tin particles, nickel particles, aluminum oxide particles, zirconium oxide particles, aluminum nitride particles, titanium carbide particles, titanium nitride particles, phosphor particles, or combinations thereof.

14. The wavelength conversion device as claimed in claim 1, wherein the plurality of particles are metal particles or ceramic particles.

15. The wavelength conversion device as claimed in claim 1, wherein the first photo-curable material is photo-curable glue, and before photo-curing, a viscosity of the uncured first photo-curable material mixed with the plurality of particles is greater than 60000 cps.

16. The wavelength conversion device as claimed in claim 1, wherein before photo-curing, a viscosity of the uncured first photo-curable material mixed with the plurality of particles is greater than a viscosity of the uncured second photo-curable material.

17. The wavelength conversion device as claimed in claim 1, wherein a volume percentage of the plurality of particles in the first counterweight element is from 10 vol % to 50 vol %.

18. A projection device, comprising: an illumination module, a light valve and a projection lens, wherein
the illumination module is configured to provide an illumination beam, and the illumination module comprises:
a light source device, configured to provide an excited beam; and
a wavelength conversion device, disposed on a transmission path of the excited beam, and the wavelength conversion device comprising a wavelength conversion module and a driving assembly, the driving assembly being suitable for driving the wavelength conversion module to rotate while taking a central axis as a rotating axis, and the wavelength conversion module comprising a disc, a wavelength conversion layer and a counterweight, wherein
the disc has a center located on the central axis and has a bearing surface perpendicular to the central axis;
the wavelength conversion layer is disposed on the bearing surface of the disc; and
the counterweight is disposed on the disc, and in a radial direction perpendicular to the central axis, the counterweight is closer to the central axis relative to the wavelength conversion layer, the counterweight comprises a first counterweight element, the first counterweight element comprises a first photo-curable material and a plurality of particles, the plurality of particles are evenly distributed in the first photo-curable material to form the first counterweight element, and in a direction parallel to the central axis, a plurality of particle orthogonal projections of the plurality of particles on the bearing surface at least partially overlap;
the light valve is disposed on a transmission path of the illumination beam to convert the illumination beam into an image beam; and
the projection lens is disposed on a transmission path of the image beam to project the image beam out of the projection device.

19. A method for manufacturing a counterweight, adapted to the wavelength conversion device as claimed in claim 1, and the method for manufacturing the counterweight comprising:
providing an uncured first photo-curable material, and adding the plurality of particles to the uncured first photo-curable material and mixing evenly;
filling the uncured first photo-curable material mixed with the plurality of particles into a syringe and performing defoaming;
disposing the uncured first photo-curable material mixed with the plurality of particles on the disc; and
curing to form the counterweight.

20. The method for manufacturing the counterweight as claimed in claim 19, wherein after the step of disposing the uncured first photo-curable material mixed with the plurality of particles on the disc, the method for manufacturing the counterweight further comprises:
disposing a second counterweight element onto the uncured first photo-curable material mixed with the plurality of particles; and
configuring an uncured second photo-curable material, such that the uncured second photo-curable material covers the second counterweight element and the uncured first photo-curable material mixed with the plurality of particles.
